(19) United States
(12) Patent Application Publication
(10) Pub. No.: US 2008/0307177 A1
(43) Pub. Date: Dec. 11, 2008

(54) PROGRAM CONVERSION DEVICE

(76) Inventors: Masatsugu Daimon, Nara (JP); Naoko Nakahara, Osaka (JP); Toshiyuki Sakata, Osaka (JP); Teruo Kawabata, Osaka (JP)

Correspondence Address: MCDERMOTT WILL & EMERY LLP, 600 13TH STREET, NW, WASHINGTON, DC, 20005-3096, US

(21) Appl. No.: 12/105,706

(22) Filed: Apr. 18, 2008

(30) Foreign Application Priority Data
Jun. 11, 2007 (JP) 2007-154262

(51) Int. Cl. G06F 12/02; G06F 12/16; G06F 12/14

(52) U.S. Cl. 711/162; 711/170; 711/163; 711/E12.002; 711/E12.103; 711/E12.091

(57) ABSTRACT

An analysis section analyzes the live range of a first variable shared among subroutines and the live range of a second variable used only in a subroutine. The allocation section allocates the second variable in an allocation memory for the first variable if the live ranges of the first and second variables do not overlap each other.

### CROSS-REFERENCE TO RELATED APPLICATIONS

This application claims priority under 35 U.S.C. §119 on Patent Application No. 2007-154262 filed in Japan on Jun. 11, 2007, the entire contents of which are hereby incorporated by reference.

### BACKGROUND OF THE INVENTION

The present invention relates to a program conversion device, a storage allocation method for the same and a program for the same, and more particularly, to a program conversion device in a compiler technology involving memory allocation of variables and structures declared in a programming language and the like (i.e., a technology generally called storage allocation), a storage allocation method for the same, a program for the same, and a compiler-involving program development system.

In recent years, for enhancement of the development efficiency, high-level languages typified by the C language and program conversion devices for converting such high-level languages to machine languages have been heavily used. As for products developed using such high-level languages and program conversion devices, downsizing and cost saving have been increasingly demanded, and thus increasingly severe constraints have been imposed on hardware equipment used. Along with this, it has become requisite to reduce the memory use amount of a program. Conventional program conversion devices are unable to produce assembler code with a small memory use amount comparable to that attained by skilled assembler programmers. How to bring the assembler code closer to this level is therefore a challenge, and various attempts are underway.

One of such attempts is a technique of reducing the use amount of a stack that is a special memory area virtually separated by the program conversion device. The stack, which is a memory area where local data used for each function is stored, is secured when required at the time of use of the function during execution of a program. A function is sometimes called from itself any number of times (recursive call). In such a case, therefore, reducing the stack use amount for each function will contribute to wide reduction in memory use amount.

For example, Japanese Laid-Open Patent Publication No. 8-153006 (Patent Document 1) describes a technique in which the stack use amount is reduced by optimizing the order of allocation of variables on the stack.

Although not related to the stack, Japanese Laid-Open Patent Publication No. 2000-112767 (Patent Document 2) describes a technique in which, in memory allocation of automatic variables that are variables used for each function, the same memory area is shared between automatic variables in a function that are not used simultaneously, to thereby reduce the memory use amount.

However, the techniques in Patent Documents 1 and 2 described above have the problem that there is still room for further reduction in stack use amount because the same memory area is not shared among a plurality of variables or, the sharing, if any, is only between variables of the same attribute, such as between automatic variables.

### SUMMARY OF THE INVENTION

An object of the present invention is providing a program conversion device permitting further reduction in stack use amount, in which the live ranges of variables of different attributes, such as an argument and an automatic variable, for example, are analyzed, and if the live ranges do not overlap each other, even such variables of different attributes are allocated on a same stack area.

According to one aspect of the present invention, the program conversion device includes: an analysis section for analyzing a live range of a first variable shared among subroutines and a live range of a second variable used only in a subroutine; and an allocation section for allocating the second variable in an allocation memory for the first variable if the live ranges of the first and second variables do not overlap each other. In this program conversion device, the stack use amount can be reduced.

In the program conversion device described above, preferably, the first variable is an actual argument and the second variable is an automatic variable. In this program conversion device, the actual argument area is effectively used, to permit reduction in stack use amount.

In the program conversion device described above, preferably, the first variable is a dummy argument and the second variable is an automatic variable. In this program conversion device, the dummy argument area is effectively used, to permit further reduction in stack use amount.

In the program conversion device described above, preferably, the analysis section analyzes whether or not the values of an actual argument and an automatic variable are equal to each other in their existing segments, and if they are equal to each other, the allocation section preferentially allocates the automatic variable in an actual argument area. In this program conversion device, redundant instruction code is reduced, to permit reduction in program execution time and reduction in the use amount of the memory area in which instruction code is stored, in addition to the reduction in stack use amount.

In the program conversion device described above, preferably, the analysis of live ranges and the allocation of memory are performed only when no debug information is generated. Overwriting an automatic variable in an argument area causes a failure in correct display of the value of an argument during debugging. In this program conversion device, however, in which no automatic variable is overwritten in an argument area during debugging, the value of an argument can be correctly displayed.

According to another aspect of the present invention, the debug device includes: a first memory area, prepared separately from a normal variable data holding area, for storing therein the value of an actual argument; an argument value saving section for copying the value of an actual argument to the first memory area every time a function call is executed; and a debug execution section that refers to the first memory area when required to refer to the value of an actual argument. In this debug device, the debugger copies the value of an argument to a different memory area, and this permits correct display of the argument value.

According to yet another aspect of the present invention, the program development system includes: a program conversion device including: an analysis section for analyzing a live range of a first variable shared among subroutines and a live range of a second variable used only in a subroutine; and an allocation section for allocating the second variable in an allocation memory for the first variable if the live ranges of the first and second variables do not overlap; and a debug device for securing a first memory area, prepared separately from a normal variable data holding area, for storing therein the value of an actual argument, copying the value of an actual argument to the first memory area every time a function call is executed; and referring to the first memory area when required to refer to the value of an actual argument. In this program development system, the stack use amount can be reduced, and also the value of an argument can be correctly displayed during debugging.

In the program development system described above, preferably, the program conversion device further includes a debug information generation section for generating debug information to be inputted into the debug device, and the debug device performs the processing depending on the debug information. In this program development system, the stack use amount can be reduced, and also the value of an argument can be correctly displayed during debugging. In addition, since the debug device copies an argument only when required, the debugging speed can be improved and the memory use amount of the debug device can be reduced.

### BRIEF DESCRIPTION OF THE DRAWINGS

FIG. 1 is a block diagram showing the entire configuration of a program conversion device of Embodiment 1 of the present invention.

FIG. 2 is a block diagram of a memory allocation section shown in FIG. 1.

FIG. 3 is a flowchart showing the processing operation of an automatic variable allocation division for argument area shown in FIG. 2.

FIG. 4 is a source code diagram showing the contents of an input file in the program conversion device of FIG. 1.

FIG. 5 is a diagrammatic view showing the analysis results on the live ranges of actual arguments and the live ranges of automatic variables by an analysis subsection shown in FIG. 2.

FIG. 6 is a diagrammatic view showing the live ranges in actual argument areas as a result of allocation by an argument allocation division for argument area shown in FIG. 2.

FIG. 7 is a diagrammatic view showing the live ranges in the actual argument areas as a result of allocation by the automatic variable allocation division for argument area shown in FIG. 2.

FIG. 8 is a diagrammatic view showing stack allocation in a conventional program conversion device.

FIG. 9 is an assembler code diagram showing the contents of an output file in the conventional program conversion device.

FIG. 10 is a diagrammatic view showing an example of stack allocation in the program conversion device of FIG. 1.

FIG. 11 is an assembler code diagram showing the contents of an output file in the program conversion device of FIG. 1.

FIG. 12 is a diagrammatic view showing the analysis results on the live range of a dummy argument and the live ranges of automatic variables by the analysis subsection shown in FIG. 2.

FIG. 13 is a diagrammatic view showing another example of stack allocation in the program conversion device of FIG. 1.

FIG. 14 is an assembler code diagram showing the contents of another output file in the program conversion device of FIG. 1.

FIG. 15 is a diagrammatic view showing yet another example of stack allocation in the program conversion device of FIG. 1.

FIG. 16 is an assembler code diagram showing the contents of yet another output file in the program conversion device of FIG. 1.

FIG. 17 is a block diagram showing the entire configuration of a debug device of Embodiment 2 of the present invention.

FIG. 18 is a flowchart showing the argument value saving by the debug device of FIG. 17.

### DESCRIPTION OF THE PREFERRED EMBODIMENTS

Hereinafter, preferred embodiments of the present invention will be described with reference to the accompanying drawings. Note that the components denoted by the same reference numeral operate in substantially the same way and thus repeated description of such components may be omitted.

### Embodiment 1

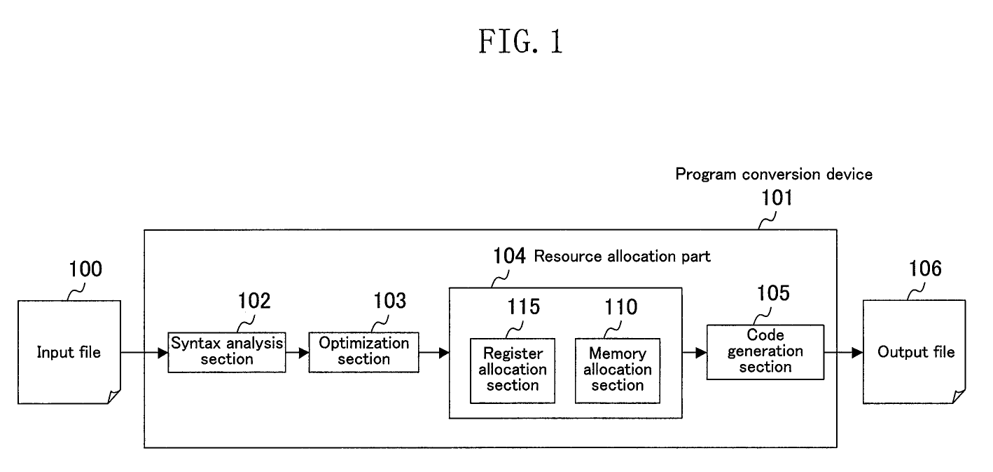

FIG. 1 shows the entire configuration of a program conversion device of Embodiment 1 of the present invention. A program conversion device 101 includes a syntax analysis section 102, an optimization section 103, a resource allocation part 104 and a code generation section 105.

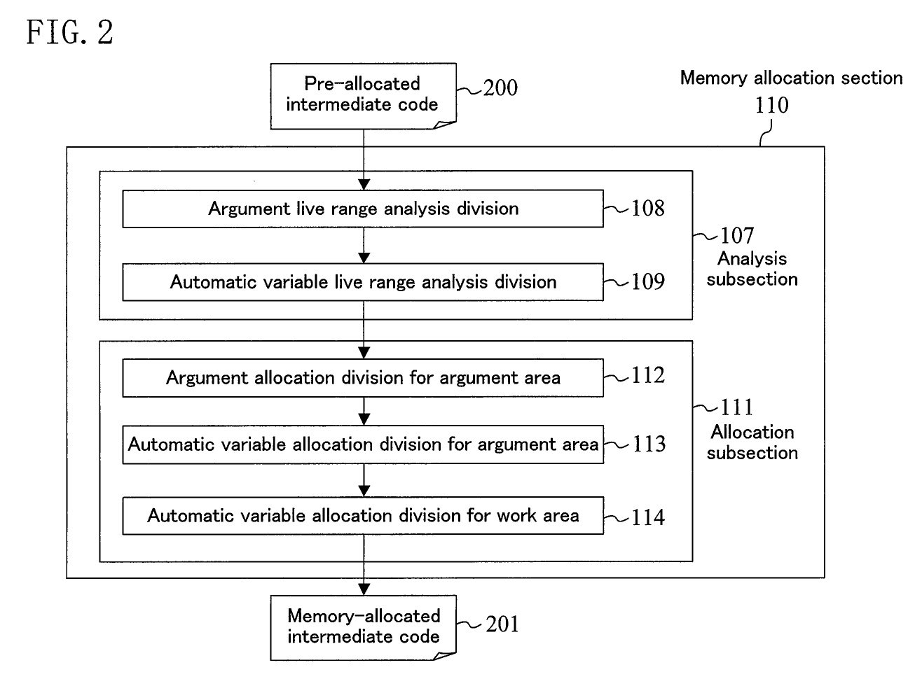

The syntax analysis section 102 analyzes an input file 100 and converts the file to a program, called intermediate code, used only inside the program conversion device 101. The optimization section 103 performs various kinds of compile optimization for the intermediate code received from the syntax analysis section 102, to enhance the execution speed performance of an output file 106 to be generated from the intermediate code and downsize the memory used. The resource allocation part 104 allocates necessary resources (register and memory) to the intermediate code. The resource allocation part 104 includes a register allocation section 115 and a memory allocation section 110, each of which has an analysis subsection 107 and an allocation subsection 111 (see FIG. 2). The code generation section 105 generates the output file 106 from the resource-allocated intermediate code.

Note that in FIG. 1 the input file 100 and the output file 106 are shown together for the sake of convenience. While the input file 100 is a file including a source program described in the C language and the like, the output file 106 is a file storing therein an assembler generated as a result of translation of the source program in the input file 100.

The operation of the program conversion device 101 of FIG. 1 will be outlined. In the program conversion device 101, the input file 100 is converted to intermediate code by the syntax analysis section 102, and then optimized by the optimization section 103. Resources such as a register and a stack are allocated to the optimized intermediate code by the resource allocation part 104, and the resultant code is converted to an assembler by the code generation section 105 and then stored in the output file 106.

Note that in the program conversion device 101, the processing of the syntax analysis section 102, the optimization section 103, the code generation section 105 and any component of the resource allocation part 104 other than the memory allocation section 110 is the same as that in the conventional compiler, and thus description of such processing is omitted here.

FIG. 2 shows a configuration of the memory allocation section 110 shown in FIG. 1. The memory allocation section 110 includes: the analysis subsection 107 for analyzing the live ranges of arguments and the live ranges of automatic variables; and the allocation subsection 111 for allocating memory (stack) to arguments and automatic variables based on the analysis information from the analysis subsection 107. The analysis subsection 107 includes an argument live range analysis division 108 and an automatic variable live range analysis division 109. The allocation subsection 111 includes an argument allocation division 112 for argument area, an automatic variable allocation division 113 for argument area and an automatic variable allocation division 114 for work area. The “live range” as used herein refers to the segment from the definition of a variable until the final use thereof.

The argument live range analysis division 108 analyzes the live range of an argument. The automatic variable live range analysis division 109 analyzes the live range of an automatic variable. The argument allocation division 112 for argument area allocates an actual argument in an argument storage area based on the analysis information from the argument live range analysis division 108. The “actual argument” as used herein refers to an argument handed over to a function at the time of use of the function. The automatic variable allocation division 113 for argument area allocates an automatic variable in the argument storage area based on the analysis information from the argument live range analysis division 108 and the automatic variable live range analysis division 109. The “automatic variable” as used herein refers to a variable used only within a given function. The automatic variable allocation division 114 for work area allocates an automatic variable in a work area based on the analysis results from the automatic variable live range analysis division 109 and the allocation results from the automatic variable allocation division 113 for argument area.

The operation of the memory allocation section 110 will be described.

The memory allocation section 110 allocates memory to pre-allocated intermediate code 200 (the intermediate code optimized by the optimization section 103). Specifically, the argument live range analysis division 108 and the automatic variable live range analysis division 109 of the analysis subsection 107 respectively analyze the live ranges of arguments and the live ranges of automatic variables. To the pre-allocated intermediate code subjected to the live range analysis, memory is allocated in stages in the allocation subsection 111 by the argument allocation division 112 for argument area, the automatic variable allocation division 113 for argument area and the automatic variable allocation division 114 for work area, to finally output memory-allocated intermediate code 201.

Note that in the memory allocation section 110, the processing of the argument live range analysis division 108 and the automatic variable live range analysis division 109 of the analysis subsection 107 and the argument allocation division 112 for argument area and the automatic variable allocation division 114 for work area of the allocation subsection 111 is the same as that in the conventional compiler, and thus description thereof is omitted here.

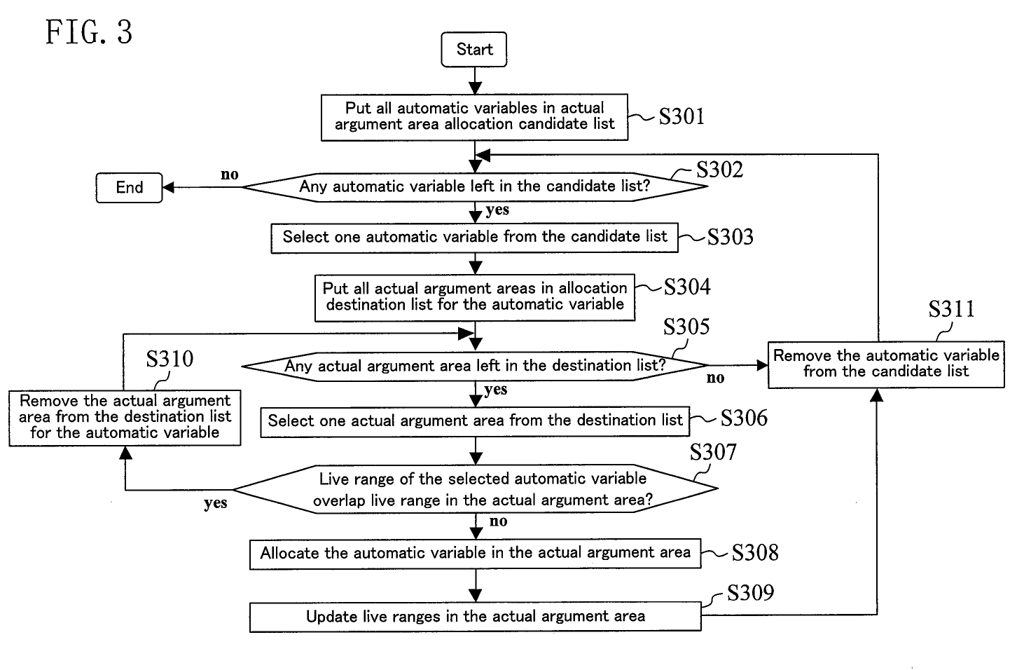

The operation of the automatic variable allocation division 113 for argument area shown in FIG. 2 will be described with reference to FIG. 3.

Once receiving the intermediate code outputted from the argument allocation division 112 for argument area, the automatic variable allocation division 113 for argument area puts all automatic variables in an actual argument area allocation candidate list (step S301). The automatic variable allocation division 113 for argument area then determines whether or not there is any automatic variable left in the candidate list (step S302). If there is no automatic variable to be stored in the candidate list, or if automatic variables left in the candidate list have been used up in the process of the automatic variable allocation by the automatic variable allocation division 113 for argument area, this processing is terminated (step S302). If there is left any automatic variable in the candidate list, the automatic variable allocation division 113 for argument area selects one automatic variable from the candidate list (step S303).

Thereafter, the automatic variable allocation division 113 for argument area puts all actual argument areas in an allocation destination list as allocation destination candidates for the automatic variable selected from the candidate list (step S304). The automatic variable allocation division 113 for argument area then determines whether or not there is any actual argument area left in the allocation destination list (step S305). If there is no actual argument area to be stored in the allocation destination list for the automatic variable, or if actual argument areas stored in the allocation destination list for the automatic variable have been used up in the subsequent processing, the automatic variable allocation division 113 for argument area removes the selected automatic variable from the candidate list (step S311), and the process returns to the step S302. If there is left any actual argument area in the allocation destination list, the automatic variable allocation division 113 for argument area selects one actual argument area from the allocation destination list (step S306).

Subsequently, the automatic variable allocation division 113 for argument area determines whether or not the live range of the selected automatic variable overlaps the live range in the selected actual argument area (step S307). If the live range of the selected automatic variable overlaps the live range in the actual argument area, the automatic variable allocation division 113 for argument area removes the actual argument area in question from the allocation destination list (step S310), and the process returns to the step S305. Note that as the live ranges in the actual argument areas, the results from the argument allocation division 112 for argument area shown in FIG. 2 are used. If the live range of the selected automatic variable does not overlap the live range in the actual argument area, the automatic variable allocation division 113 for argument area allocates the selected automatic variable in the selected actual argument area (step S308), inserting the live range of the selected automatic variable in the selected actual argument area to thereby update the live ranges in the actual argument area (step S309). The process then proceeds to the step S311 and thereafter returns to the step S302.

After the above processing, any automatic variable that has failed to be allocated in any actual argument area is allocated in the work area by the automatic variable allocation division 114 for work area. Note that the existence of any actual argument area may be confirmed before the start of the entire processing in FIG. 3, and if no such area exists, the processing in FIG. 3 may not be performed to reduce redundant processing.

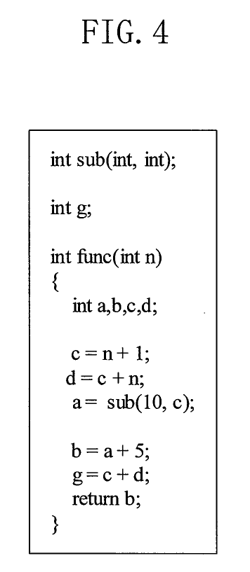

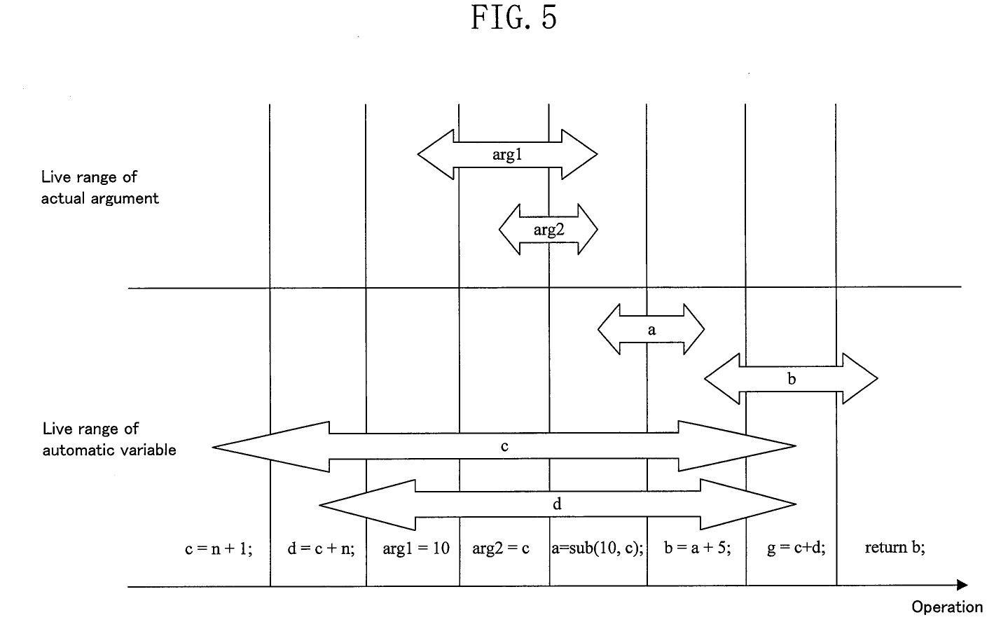

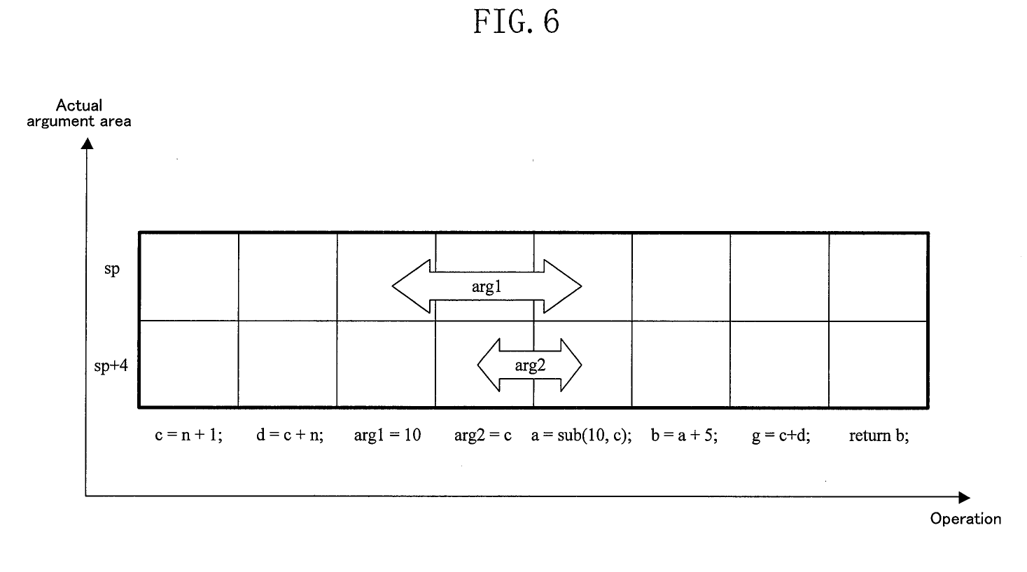

A specific operation of the automatic variable allocation division 113 for argument area will be described using an input program shown in FIG. 4. The analysis subsection 107 performs live range analysis for the input program of FIG. 4, to obtain the analysis results as shown in FIG. 5. The argument allocation division 112 for argument area allocates arguments in the argument areas based on the results of FIG. 5, to obtain the allocation results as shown in FIG. 6. Based on these results of FIGS. 5 and 6, the automatic variable allocation division 113 for argument area allocates automatic variables in the argument area.

Specifically, the automatic variable allocation division 113 for argument area puts all automatic variables in the actual argument area allocation candidate list (step S301). Thus, “a”, “b”, “c” and “d” are put in the candidate list. With the “a”, “b”, “c” and “d” being stored in the candidate list, the automatic variable allocation division 113 for argument area determines that there are automatic variables left in the candidate list (S302). The automatic variable allocation division 113 for argument area then selects “a” (step S303) and puts “sp” and “sp+4” in the allocation destination list for “a” (step S304).

With “sp” and “sp+4” being put in the allocation destination list, the automatic variable allocation division 113 for argument area determines that there are actual argument areas left in the allocation destination list (S305). The automatic variable allocation division 113 for argument area then selects “sp” from the allocation destination list (step S306) and determines whether or not the live range of “a” overlaps the live range in “sp” (step S307). Since the live ranges do not overlap each other, the automatic variable allocation division 113 for argument area allocates “a” in “sp” (step S308). The automatic variable allocation division 113 for argument area inserts the live range of “a” in “sp” (step S309), and removes “a” from the candidate list (step S311). The process then returns to the determination processing in the step S302.

The process continues in a similar way to allocate “b” also in the actual argument area “sp”.

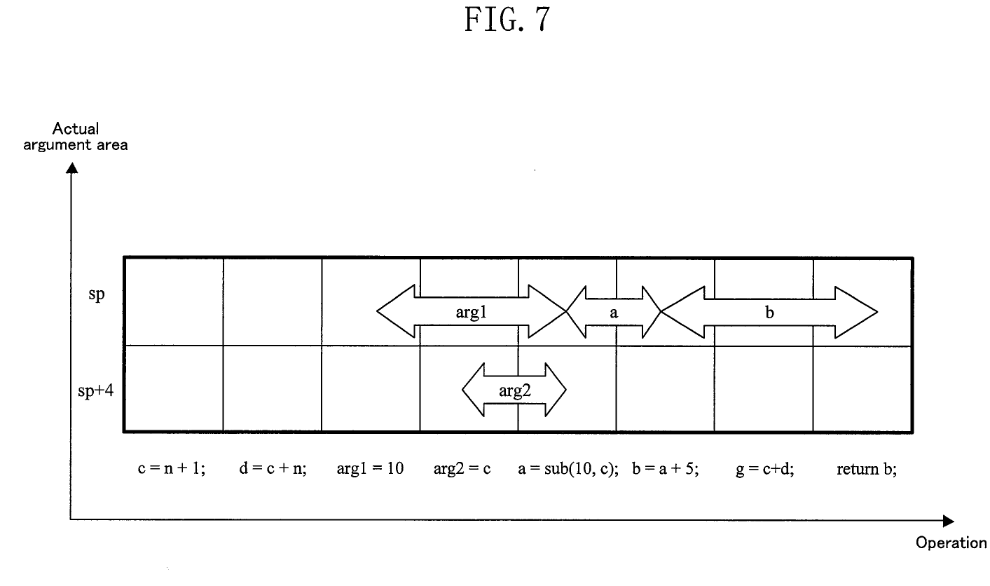

As for “c” and “d”, the live ranges thereof overlap live ranges in all actual argument areas. In the step S307, therefore, the answer is always “yes”, and the process continues without branching to “no”. Finally, the answer is “no” in the step S302, to terminate the processing by the automatic variable allocation division 113 for argument area without allocation of “c” and “d”. The automatic variables “c” and “d” are allocated in a work area in the next processing by the automatic variable allocation division 114 for work area. As a result, as shown in FIG. 7, the actual argument area “sp” can be allocated to the automatic variables “a” and “b”.

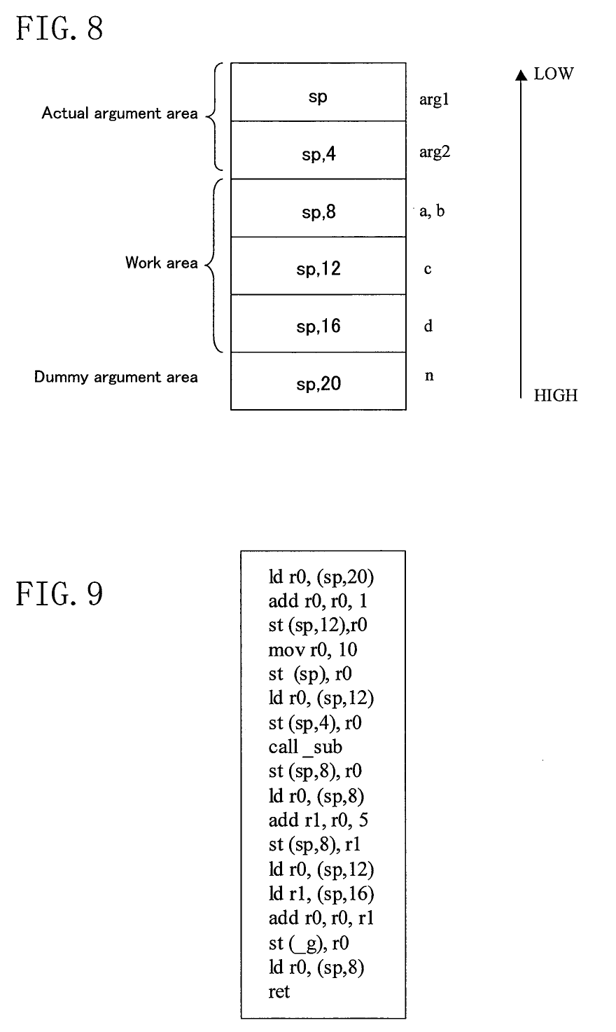

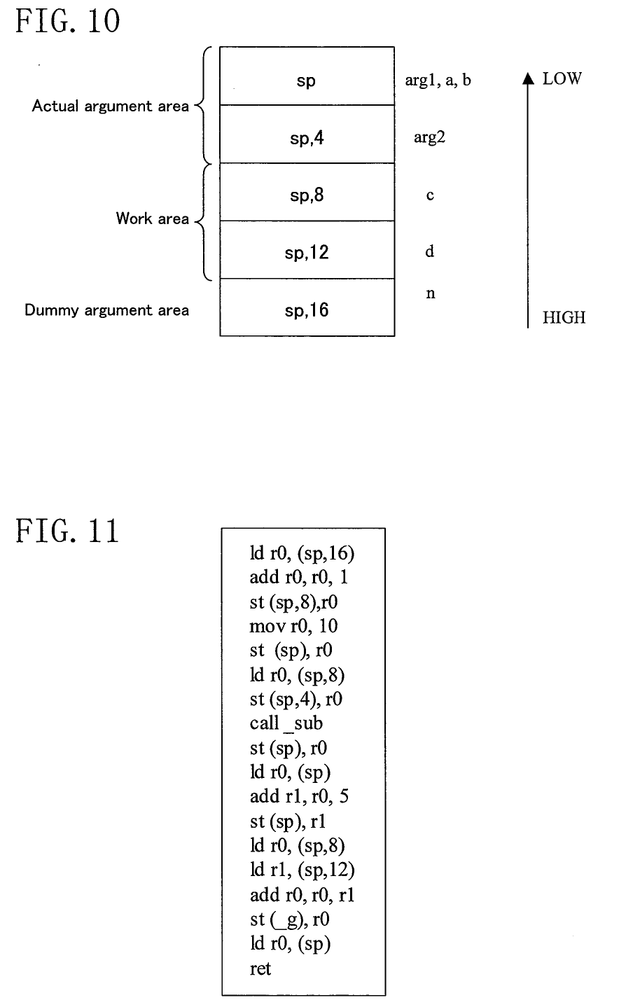

Conventionally, by using a 6-word stack as shown in FIG. 8, output code as shown in FIG. 9 can be obtained. In this embodiment, however, a 5-word stack can be attained, and output code as shown in FIG. 11 is stored in the output file 106.

Thus, according to this embodiment, the use amount of the stack for each function can be reduced. If the function is recursively called, the reduction amount will sum to the number of calls x the stack reduction amount per function. A very large effect of reducing the stack use amount is therefore attained.

In this embodiment, the description was made using int-type variables as an example. It is needless to mention that as for other types of arguments such as a scalar type and an aggregate type, the stack use amount can be reduced in a similar way by dividing the area into a plurality of portions or other means.

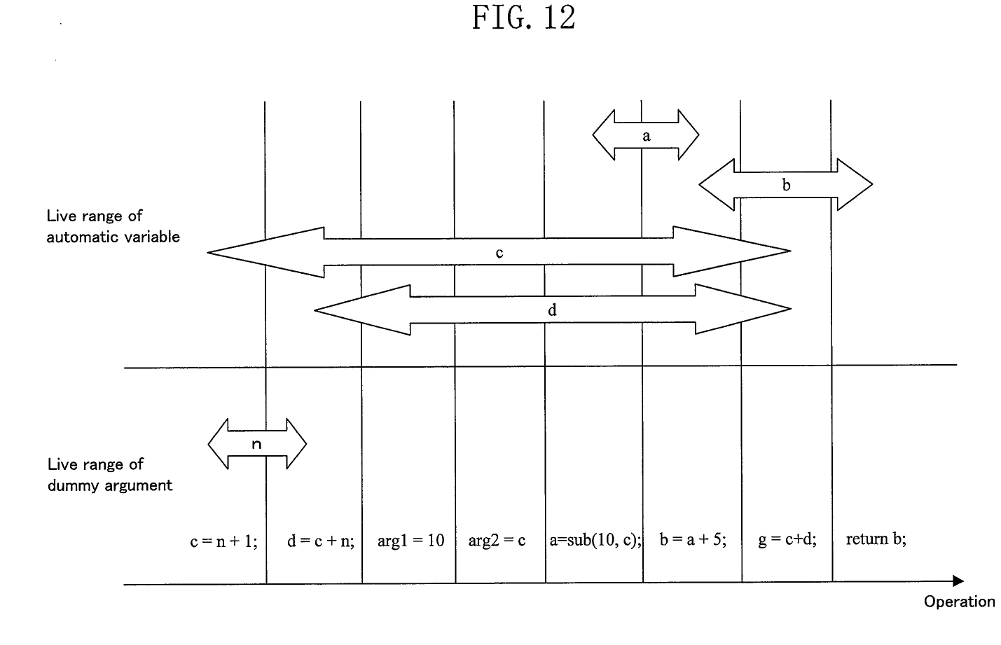

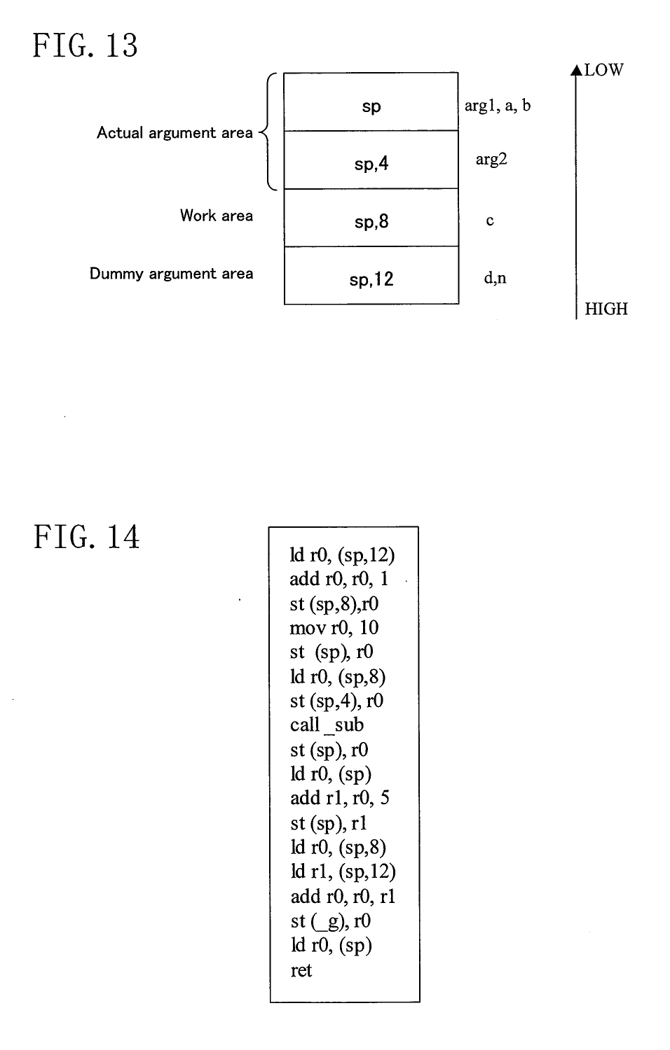

In this embodiment, automatic variables were allocated only in actual argument areas. Automatic variables may also be allocated in a dummy argument area. This allocation in a dummy argument area can be attained by adding the dummy argument area to the actual argument area in the steps S301, S304, S305, S306, S307, S308, S309, S310 and S311. In this case, by analyzing the live ranges of the dummy argument and the automatic variables for the input program shown in FIG. 4, the analysis results as shown in FIG. 12 are obtained. Among the variables other than “a” and “b” already allocated in the actual argument area, “d” does not overlap the live range of the dummy argument. Therefore, in the step S308, the automatic variable allocation division 113 for argument area allocates “d” in the dummy argument area. As a result, with the allocation of “d” in the stack area for the dummy argument “n”, the stack allocation as shown in FIG. 13 is obtained, which gives a 4-word stack further reduced by one word. Also, output code as shown in FIG. 14 is stored in the output file 106.

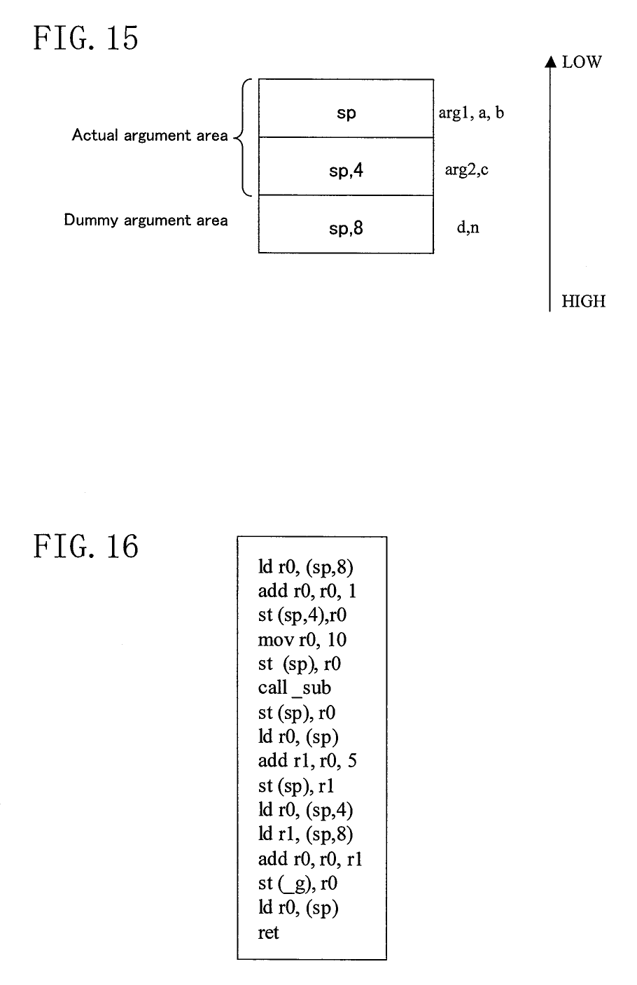

In this embodiment, an argument and an automatic variable whose live ranges do not overlap each other are allocated in the argument area. However, as long as the values thereof are equal to each other, they may be allocated in the argument area even if the live ranges thereof overlap each other. This processing can be realized by adding the step of determining whether or not the values of an argument and an automatic variable are equal to each other between the steps S307 and S310. In this equality determination step, if the values are equal to each other, the process proceeds to the step S308, or otherwise the process proceeds to the step S310. This equality determination may be performed in the automatic variable allocation division 113 for argument area, or in the analysis subsection 107. Specifically, the case of performing this equality determination for the input program of FIG. 4 will be described. In this case, the values are determined equal to each other when the argument selected in the step S306 is the second argument (arg2) of the function sub and the automatic variable selected in the step S303 is “c”. In the step S308, therefore, “c” is allocated in the stack area for “arg2”, resulting in the stack allocation as shown in FIG. 15, which gives a stack further reduced by one word. Also, output code as shown in FIG. 16 is stored in the output file 106. The number of instructions in the output code can be reduced to 16 from 18, permitting reduction in the use amount of the instruction code storage. In addition, with the reduction in instruction code, the program execution speed can be improved.

In this embodiment, an automatic variable was stored in an argument area irrespective of whether or not debugging is performed. In this case, a problem may arise that correct argument information may not be referred to during debugging. For this reason, the processing in the automatic variable allocation division 113 for argument area may be omitted when debugging is performed. This omission can be realized by adding the step of determining whether or not a debug information generation option as a compile option has been designated before the step S301. In this determination step, if the debug information generation option has been designated, the process is terminated, or otherwise the process proceeds to the step S301. In this way, during development, the debug information generation option may be designated to ensure correct debugging. During implementation into a product, the debug information generation option may not be designated to permit reduction in memory use amount.

### Embodiment 2

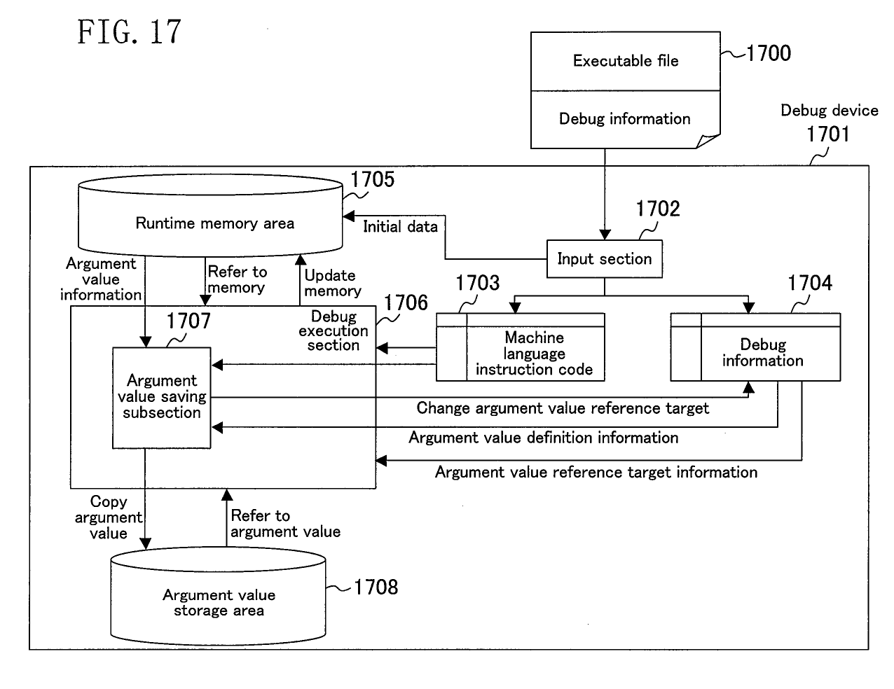

FIG. 17 shows the entire configuration of a debug device of Embodiment 2 of the present invention. A debug device 1701 includes an input section 1702 and a debug execution section 1706.

The input section 1702, which receives an executable file 1700, divides the inputted executable file 1700 into a machine language instruction code 1703 and debug information 1704 and also stores initial data in a runtime memory area 1705. The debug execution section 1706 executes debugging using the machine language instruction code 1703, the debug information 1704, the runtime memory area 1705, an argument value saving subsection 1707 and an argument value storage area 1708. The machine language instruction code 1703 is an instruction code in a machine language to be debugged by the debug device 1701. The debug information 1704 is compiler-generated hint information to be used at debugging, which is referred to by the debug device 1701 as required. The runtime memory area 1705 is an area in which data defined/used by the machine language is stored during debugging, which is updated as required every time a machine language instruction is executed. The argument value saving subsection 1707 copies an argument value to the argument value storage area 1708 and changes the reference target of an argument in the debug information to the copy target. The argument value storage area 1708 is an area in which an argument value is stored by the argument value saving subsection 1707. The debug execution section 1706 refers to an argument value in the argument value storage area 1708 as required.

For the sake of convenience, the executable file 1700 is also shown in FIG. 17. The executable file 1700, which is a file generated by the program conversion device 101 of FIG. 1, includes the machine language instruction code, the debug information and the initial data.

The operation of the debug device 1701 of FIG. 17 will be described.

Once receiving the executable file 1700, the input section 1702 of the debug device 1701 divides the file into the machine language instruction code 1703 and the debug information 1704 and also stores the initial data in the runtime memory area 1705. Upon completion of the input, the debug execution section 1706 starts working to read the machine language instruction code 1703 for debugging. The debug execution section 1706 refers to the debug information 1704, and also refers to and updates the runtime memory area 1705, as required. The processing so far is the same as that of conventional debug devices. The debug execution section 1706 further performs argument value saving process when an argument is defined in a machine language instruction. Determination on whether or not an argument is defined is made using argument value definition information in the debug information 1704.

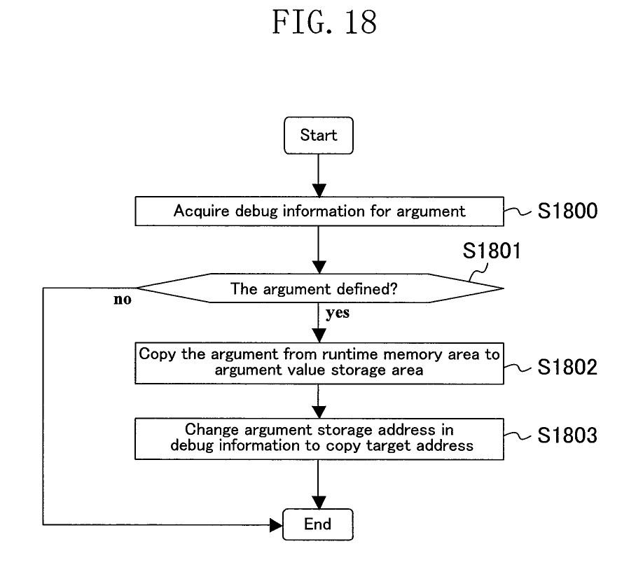

The operation of the argument value saving subsection 1707 shown in FIG. 17 will be described with reference to FIG. 18.

The argument value saving subsection 1707 first acquires debug information for an argument (step S1800), and determines, from this information, whether or not the argument is defined in an instruction of which execution is intended (step S1801). If not defined, no saving of the argument value is necessary, and thus the processing is terminated. If defined, the argument value saving subsection 1707 copies the value of the argument stored in the runtime memory area 1705 to the argument value storage area 1708 (step S1802). The argument value saving subsection 1707 then changes the argument storage address in the debug information 1704 to the copy target (step S1803).

If the target address has already been changed, another change is no more required. It is therefore unnecessary to execute the step S1803.

A specific operation of the argument value saving subsection 1707 will be described using an executable file converted from the assembler program shown in FIG. 16.

During the execution of the first ld instruction, the argument value saving subsection 1707, called by the debug execution section 1706, acquires debug information for an argument in the first ld instruction (step S1800). Since no argument is defined in any 1d instruction, the processing by the argument value saving subsection 1707 is terminated. This also applies to the next add instruction.

During the execution of the next st instruction, the argument value saving subsection 1707, called by the debug execution section 1706, acquires debug information (step S1800). In this case, since the second argument (arg2) is defined, the answer in the step S1801 is “yes”. In the step S1802, therefore, the argument value saving subsection 1707 copies the value to be defined (i.e., “arg2”) from its stored position in the runtime memory area 1705 to the argument value storage area 1708. In the step S1803, the argument value saving subsection 1707 changes the argument storage address for the second argument (arg2) in the debug information to the address in the argument value storage area 1708 to which the value to be defined (i.e., “arg2”) has been copied in the step S1802. The above processing is repeated, to find that the answer in S1801 is “yes” in the st instruction at the fifth line from the top and “no” in all the other instructions. As a result, the argument values of “arg1” and “arg2” are copied to the argument value storage area 1708. In subsequent reference to the argument values of “arg1” and “arg2”, if any, the debug device 1701 refers to the argument value storage area 1708.

A program development system may be configured combining the program conversion device of FIG. 1 and the debug device of FIG. 17. In this case, the program conversion device outputs debug information on whether or not an automatic variable has been stored in an argument area, and the debug device determines whether or not the argument value saving should be performed based on the debug information. This can reduce the redundant processing that may occur when no argument value saving is performed, and thus improves the debug efficiency.

The present invention is not limited to the embodiments described above and can be modified in numerous ways. Such modifications naturally fall within the scope of the present invention.

As described above, the present invention permits further reduction in stack use amount compared with that conventionally achieved, and thus is useful in particular as a program conversion device, an embedded program development system and the like.

What is claimed is:

1. A program conversion device comprising:
an analysis section for analyzing a live range of a first variable shared among subroutines and a live range of a second variable used only in a subroutine; and
an allocation section for allocating the second variable in an allocation memory for the first variable if the live ranges of the first and second variables do not overlap each other.

2. The program conversion device of claim 1, wherein the first variable is an actual argument and the second variable is an automatic variable.

3. The program conversion device of claim 1, wherein the first variable is a dummy argument and the second variable is an automatic variable.

4. The program conversion device of claim 2, wherein the analysis section analyzes whether or not the values of an actual argument and an automatic variable are equal to each other in their existing segments, and
if they are equal to each other, the allocation section preferentially allocates the automatic variable in an actual argument area.

5. The program conversion device of claim 1, wherein the analysis of live ranges and the allocation of memory are performed only when no debug information is generated.

6. A debug device comprising:
a first memory area, prepared separately from a normal variable data holding area, for storing therein the value of an actual argument;
an argument value saving section for copying the value of an actual argument to the first memory area every time a function call is executed; and
a debug execution section that refers to the first memory area when required to refer to the value of an actual argument.

7. A program conversion method comprising the steps of:
(a) analyzing a live range of a first variable shared among subroutines;
(b) analyzing a live range of a second variable used only in a subroutine; and
(c) allocating the second variable in an allocation memory for the first variable if the live ranges of the first and second variables do not overlap.

8. A program for allowing a computer to execute the steps of:
(a) analyzing a live range of a first variable shared among subroutines;
(b) analyzing a live range of a second variable used only in a subroutine; and
(c) allocating the second variable in an allocation memory for the first variable if the live ranges of the first and second variables do not overlap.

9. A recording medium storing therein a program for allowing a computer to execute the steps of:
(a) analyzing a live range of a first variable shared among subroutines;
(b) analyzing a live range of a second variable used only in a subroutine; and
(c) allocating the second variable in an allocation memory for the first variable if the live ranges of the first and second variables do not overlap.

10. A debug method comprising the steps of:
(a) securing a first memory area, prepared separately from a normal variable data holding area, for storing therein the value of an actual argument;
(b) copying the value of an actual argument to the first memory area every time a function call is executed during execution; and
(c) referring to the first memory area when required to refer to the value of an actual argument.

11. A program for allowing a computer to execute the steps of:
(a) securing a first memory area, prepared separately from a normal variable data holding area, for storing therein the value of an actual argument;
(b) copying the value of an actual argument to the first memory area every time a function call is executed during execution; and
(c) referring to the first memory area when required to refer to the value of an actual argument.

12. A recording medium storing therein a program for allowing a computer to execute the steps of:
(a) securing a first memory area, prepared separately from a normal variable data holding area, for storing therein the value of an actual argument;
(b) copying the value of an actual argument to the first memory area every time a function call is executed during execution; and
(c) referring to the first memory area when required to refer to the value of an actual argument.

13. A program development system comprising:
a program conversion device including: an analysis section for analyzing a live range of a first variable shared among subroutines and a live range of a second variable used only in a subroutine; and an allocation section for allocating the second variable in an allocation memory for the first variable if the live ranges of the first and second variables do not overlap; and
a debug device for securing a first memory area, prepared separately from a normal variable data holding area, for storing therein the value of an actual argument, copying the value of an actual argument to the first memory area every time a function call is executed; and referring to the first memory area when required to refer to the value of an actual argument.

14. The program development system of claim 13, wherein the program conversion device further includes a debug information generation section for generating debug information to be inputted into the debug device, and
the debug device performs the processing depending on the debug information.
